(19) United States
(12) Patent Application Publication
(10) Pub. No.: US 2009/0303477 A1
(43) Pub. Date: Dec. 10, 2009

(54) Reagent-Less Test Strip System for Analyte Measurement and Method of Use

(76) Inventor: John F. Burd, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 12/136,270

(22) Filed: Jun. 10, 2008

(51) Int. Cl. G01J 3/28

(52) U.S. Cl. 356/326

(57) ABSTRACT

A reagent-less test strip system including a spectrometer; a test strip with a membrane for receiving a test sample, the membrane configured to separate the test sample into at least the following: one or more components that would interfere with measurement by the spectrometer and one or more components including one or more analytes that are to be measured by the spectrometer. The spectrometer measures from the test strip the separated one or more components including one or more analytes that are to be measured by the spectrometer without measuring the separated one or more components that would interfere with measurement by the spectrometer.

### FIELD OF THE INVENTION

The present invention relates to analyte measurement test strips.

### BACKGROUND

Today there are test strips available to measure a variety of analytes. These analytes include glucose, fructosamine, protein, lactate, cholesterol, drugs, drug metabolites and many others. The test strips require reagents which specifically react with the analyte and generate a color, fluorescence or electrochemical response. This response is measured by an appropriate instrument (or read visually) and the results reported.

### SUMMARY

An aspect of the present invention involves a reagent-less test strip system for measuring a variety of analytes. The test strip system includes a test strip with a membrane or membranes attached to a plastic holder, and a spectrometer for reading the test results. The membrane or membranes of the test strip separates a test sample into more than one component. One or more components that would interfere with measurement by the spectrometer are separated by the membrane from one or more components including one or more analytes that are to be measured by the spectrometer. The one or more separated components including one or more analytes are measured by the spectrometer and the results reported.

Another aspect of the invention involves a method of using a reagent-less test strip system including providing the reagent-less test strip system described immediately above providing a test sample on the membrane of the test strip; separating with the membrane the test sample into one or more components that would interfere with measurement by the spectrometer and one or more components including one or more analytes that are to be measured by the spectrometer; and measuring with the spectrometer from the test strip the separated one or more components including one or more analytes that are to be measured by the spectrometer without measuring the separated one or more components that would interfere with measurement by the spectrometer.

A further aspect of the invention involves a reagent-less test strip including a plastic holder; and a membrane attached to the plastic holder for receiving a test sample, the membrane configured to separate the test sample into at least the following: one or more components that would interfere with measurement by a spectrometer and one or more components including one or more analytes that are to be measured by the spectrometer.

Other features and advantages of the present invention will become more readily apparent to those of ordinary skill in the art after reviewing the following detailed description and any accompanying drawings.

### BRIEF DESCRIPTION OF THE DRAWINGS

FIG. 1 is an exploded perspective view of an embodiment of reagent-less test strip system.

FIG. 2 is a simplified side view of an embodiment of a reagent-less test strip system similar to the reagent-less test strip system of FIG. 1.

FIG. 3 is a simplified side view of an embodiment of the reagent-less test strip of reagent-less test strip system, and shows a drop of blood being applied to the test strip.

FIG. 4 is a side view of an exemplary membrane that may be used in the reagent-less test strip system.

FIG. 5 is a simplified side view of the reagent-less test strip of FIG. 2, and shows a membrane of the test strip allowing only plasma to reach the bottom of the test strip while holding red blood cells (which would interfere with measurement) on top of the membrane.

### DETAILED DESCRIPTION

Certain embodiments as disclosed herein provide for a reagent-less test strip system 100 for measuring a variety of analytes and a method of using the reagent-less test strip system 100.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in any appended claims.

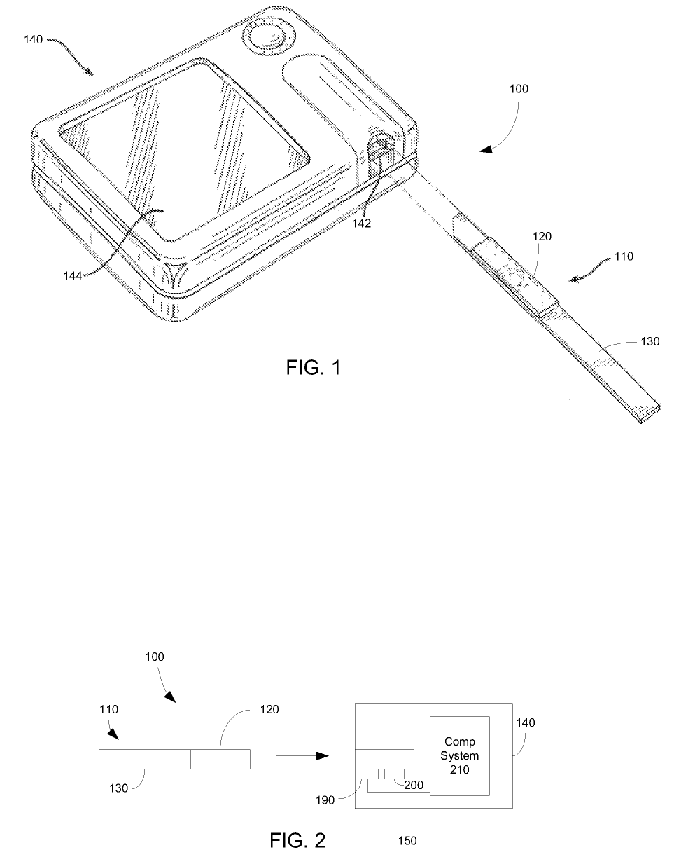

With reference to FIGS. 1 and 2, the reagent-less test strip system 100 includes a test strip 110 with a membrane (or membranes) 120 attached to a plastic holder 130, and a spectrometer 140 for reading the test results. The membrane(s) 120 may be disposed in various positions/locations relative to the holder 130 such as on top of the holder 130 as shown in FIG. 1, at an end of the holder 130 as shown in FIGS. 2, 3, and 5, or in other positions/locations not shown relative to the holder 130. The test strip 110 is adapted to be inserted into an opening 142 of the spectrometer 140. The spectrometer 140 has on its top surface a screen 144 on which the results of an analyte measurement (e.g., glucose measurement) are displayed. The screen 144 can also display instructions, error warnings, and other messages.

Certain membranes are especially advantageous for practicing this invention, as the following example will demonstrate.

### Example for Measuring Glucose in Blood:

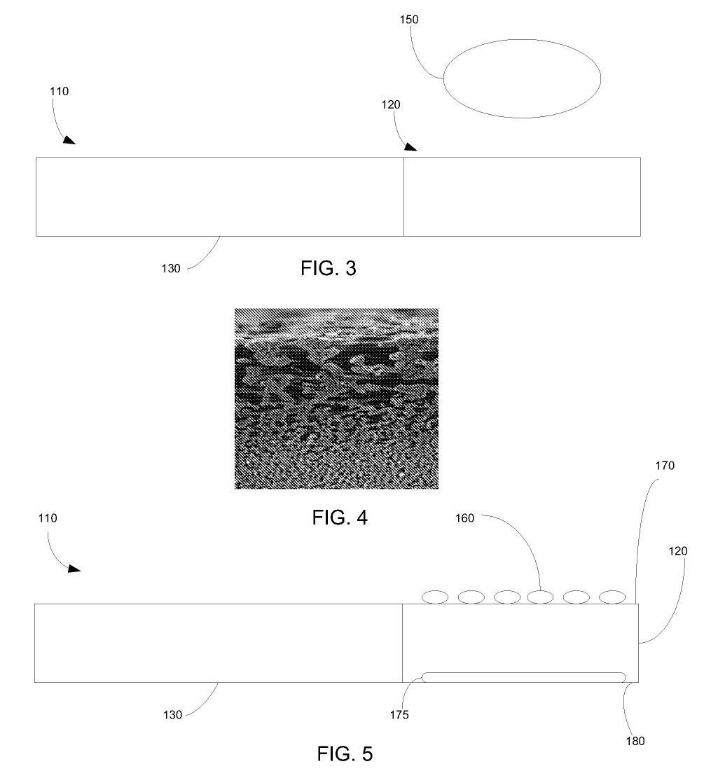

With reference to FIG. 3, a test sample of blood 150 is placed onto the test strip 110 using a BTS membrane 120 from Pall Corporation of East Hills, N.Y. The test sample of blood 150 may be a finger prick blood test sample or the sample of blood may be obtained through other methods (e.g., from an intravenous blood line running from the patient). Some of the features of the BTS membrane are described below. The membrane 120 allows fast flow, a low pressure drop, and high consistency. The membrane is constructed of pure polysulfone and post-treated for instant wettability. The membrane 120 is a highly asymmetric membrane with pores that gradually decrease in size from the upstream side to the downstream side, as shown in FIG. 4. The larger pores on the upstream side act as a prefilter while the absolute rated downstream side, or exclusion zone, acts as an absolute cut off layer. This construction can considerably extend membrane life. Other microporous membranes are cast in a conventional manner, which result in comparable pore sizes on both the upstream and downstream sides. The “cut off” layer in the BTS membrane is only about 10 μm thick, versus conventional membranes with cut off layers of approximately 100-125 μm thickness. This differential gives the BTS highly asymmetric membrane significantly higher flow with much lower pressure drop.

The following are some further specifications of the BTS membrane: standard thickness is 125 μm, sterilization is EtO, Gamma, protein adsorption is 6 μg/cm2 for 0.45 μm filter, extractables include Water <0.6%, Ethanol <2%, tensile strength is >3 MPa (400 psi), post-treatment is Hydroxypropylcellulose, diagnostic grade coefficient of variation (CV) includes thickness: down web 2%, cross web 2.5%. The following is a table of minimum bubble points and minimum water flow rates for different pore sizes of the BTS membrane:

| | Minimum Bubble | Minimum Water Flow Rate |
|---|---|---|
| Pore Size (psi) | Point (psi) | (mL/min, 90 mm disct @ 10 psi) |
| 0.8 μm | NA | 6000 |
| 0.45 μm | 18 | 2700 |
| 0.3 μm | 40 | 1500 |
| 0.2 μm | 47 | 1100 |
| 0.1 μm | 55 | 700 |
| 0.05 μm | 80 | 400 |

This table represents typical values. Cross web thickness CV is within 3%.

As shown in FIG. 5, the membrane 120 holds red blood cells 160 on a top 170 of the membrane 120 and allows blood plasma 175 to migrate to a bottom 180 of the test strip 110.

In an alternative embodiment, the test strip 110 includes more than one membrane 120 to remove other potential interferences, besides the red blood cells. For example, if there was an interference that bound specifically to a second membrane, it could also be included on the test strip 110 to remove that interference.

The spectrometer 140, which in this example is a mid-infrared spectrometer, includes a mid-IR emitter 190 that shines mid-IR light onto the bottom portion 180 of the test strip and a mid-IR detector 200 reads the mid-IR signal reflected from the plasma sample 175. The mid-IR emitter 190 and the mid-IR detector 200 are in communication with or part of a computer system (“comp system”) 210 of the spectrometer 140.

In alternative embodiments, the reagent-less test strip system 100 uses other regions of the electromagnetic spectrum, including, but not limited to, near IR, far IR, visible light, UV light, or a combination of these.

Other membranes may be placed on top of the reagent-less membrane to eliminate potential interferences and/or enhance or concentrate the analyte of interest.

This reagent-less test strip system 100 has multiple advantages, some of which include:

1. The membrane 120 allows only plasma to reach the bottom of the test strip 110, holding red blood cells (which would interfere with measurement) on top of the membrane 120.

2. Mid IR will generate most of the signal from the air-plasma interface, so that quantitation will not be effected by the amount of plasma on the bottom of the strip. This makes the volume of sample applied to the test strip less of an issue.

3. The mid IR is the so-called “fingerprint” region of the electromagnetic spectrum, so that many analytes will have a unique signature that can be measured and quantitated.

4. It may be possible to measure more than one analyte simultaneously, for example glucose and fructosamine or glucose and lactate.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in any claims that follow, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I claim:

1. A reagent-less test strip system, comprising:
a spectrometer;
a test strip with a membrane for receiving a test sample, the membrane configured to separate the test sample into at least the following: one or more components that would interfere with measurement by the spectrometer and one or more components including one or more analytes that are to be measured by the spectrometer,
wherein the spectrometer measures from the test strip the separated one or more components including one or more analytes that are to be measured by the spectrometer without measuring the separated one or more components that would interfere with measurement by the spectrometer.

2. The reagent-less test strip system of claim 1, wherein the spectrometer includes an electromagnetic energy emitter that directs electromagnetic energy onto a portion of the test strip that includes the separated one or more components including one or more analytes that are to be measured by the spectrometer, and an electromagnetic energy detector that reads electromagnetic energy reflected from the one or more components including one or more analytes that are to be measured by the spectrometer.

3. The reagent-less test strip system of claim 2, wherein the electromagnetic energy is mid-IR.

4. The reagent-less test strip system of claim 2, wherein the electromagnetic energy is one or more of near IR, far IR, visible light, and UV light.

5. The reagent-less test strip system of claim 1, wherein the membrane is a highly asymmetric membrane with pores that gradually decrease in size from an upstream side to a downstream side, wherein the one or more components that would interfere with measurement by the spectrometer are retained at the upstream side and the one or more components including one or more analytes that are to be measured by the spectrometer are not retained by the upstream side and flow to the downstream side.

6. The reagent-less test strip system of claim 5, wherein the test sample is a blood sample, the one or more components that would interfere with measurement by the spectrometer include red blood cells, and the one or more components including one or more analytes that are to be measured by the spectrometer include blood plasma.

7. The reagent-less test strip system of claim 5, wherein the one or more analytes include glucose.

8. A method of using a reagent-less test strip system, comprising:
providing the reagent-less test strip system of claim 1,
providing a test sample on the membrane of the test strip;
separating with the membrane the test sample into one or more components that would interfere with measurement by the spectrometer and one or more components including one or more analytes that are to be measured by the spectrometer;
measuring with the spectrometer from the test strip the separated one or more components including one or more analytes that are to be measured by the spectrometer without measuring the separated one or more components that would interfere with measurement by the spectrometer.

9. A reagent-less test strip, comprising:
a plastic holder;
a membrane attached to the plastic holder for receiving a test sample, the membrane configured to separate the test sample into at least the following: one or more components that would interfere with measurement by a spectrometer and one or more components including one or more analytes that are to be measured by the spectrometer.

10. The reagent-less test strip of claim 9, wherein the membrane is a highly asymmetric membrane with pores that gradually decrease in size from an upstream side to a downstream side, wherein the one or more components that would interfere with measurement by the spectrometer are retained at the upstream side and the one or more components including one or more analytes that are to be measured by the spectrometer are not retained by the upstream side and flow to the downstream side.

11. The reagent-less test strip of claim 10, wherein the test sample is a blood sample, the one or more components that would interfere with measurement by the spectrometer include red blood cells, and the one or more components including one or more analytes that are to be measured by the spectrometer include blood plasma.

12. The reagent-less test strip system of claim 11, wherein the one or more analytes include glucose.
